(19) United States
(12) Patent Application Publication
(10) Pub. No.: US 2021/0035181 A1
(43) Pub. Date: Feb. 4, 2021

(54) INSTANT VEHICLE TRADING

(71) Applicant: CarOffer, LLC, Plano, TX (US)

(72) Inventors: Bruce T. Thompson, Dallas, TX (US); Sherif Jitan, Dallas, TX (US); Ziad Chartouni, Dallas, TX (US); Paneer Shekar, Plano, TX (US)

(21) Appl. No.: 16/947,322

(22) Filed: Jul. 28, 2020

Related U.S. Application Data
(60) Provisional application No. 62/881,154, filed on Jul. 31, 2019.

(51) Int. Cl. G06Q 30/06; G06Q 10/08

(52) U.S. Cl. CPC G06Q 30/0629; G06Q 10/08345; G06Q 30/0607; G06Q 30/0639

(57) ABSTRACT

A vehicle trading platform for providing seamless integration between different aspects of fleet management includes at least one memory and at least one processor. The at least one memory is configured to store a buy matrix database including multiple buy matrices, where each buy matrix includes one or more purchasing rules. The at least one processor is configured to receive a specification of a target vehicle from a selling dealer, compare the specification of the target vehicle with the purchasing rules of the buy matrices, and provide a matched offer for the target vehicle to the selling dealer based on a result of comparing the specification of the target vehicle with the buy matrices.

### CROSS-REFERENCE TO RELATED APPLICATION AND PRIORITY CLAIM

This application claims priority under 35 U.S.C. § 119(e) to U.S. Provisional Patent Application No. 62/881,154 filed on Jul. 31, 2019. This provisional application is hereby incorporated by reference in its entirety.

### TECHNICAL FIELD

This application relates generally to fleet optimization and, more specifically, to an instant vehicle trading platform.

### BACKGROUND

Passenger vehicle dealers and other automotive dealers are facing generational challenges that threaten the survival of many. Wrong pricing and stocking strategies over the last decade have led to record margin compression. Many dealers are paying thousands of dollars per month for ineffective layered technology applications. Dealers must adopt new solutions that are radically different, and they need to do so quickly.

### SUMMARY

This disclosure provides a vehicle trading platform for fleet optimization.

In a first embodiment, a vehicle trading platform for providing seamless integration between different aspects of fleet management includes at least one memory and at least one processor. The at least one memory is configured to store a buy matrix database including multiple buy matrices, where each buy matrix includes one or more purchasing rules. The at least one processor is configured to receive a specification of a target vehicle from a selling dealer, compare the specification of the target vehicle with the purchasing rules of the buy matrices, and provide a matched offer for the target vehicle to the selling dealer based on a result of comparing the specification of the target vehicle with the buy matrices.

In a second embodiment, a method for providing a vehicle trading platform that supports seamless integration between different aspects of fleet management includes storing a buy matrix database including multiple buy matrices, where each buy matrix includes one or more purchasing rules. The method also includes receiving a specification of a target vehicle from a selling dealer. The method further includes comparing the specification of the target vehicle with the purchasing rules of the buy matrices. In addition, the method includes providing a matched offer for the target vehicle to the selling dealer based on a result of comparing the specification of the target vehicle with the buy matrices.

In a third embodiment, a non-transitory computer readable medium contains instructions that when executed cause at least one processing device to store a buy matrix database including multiple buy matrices, where each buy matrix includes one or more purchasing rules. The medium also contains instructions that when executed cause the at least one processing device to receive a specification of a target vehicle from a selling dealer. The medium further contains instructions that when executed cause the at least one processing device to compare the specification of the target vehicle with the purchasing rules of the buy matrices. In addition, the medium contains instructions that when executed cause the at least one processing device to provide a matched offer for the target vehicle to the selling dealer based on a result of comparing the specification of the target vehicle with the buy matrices.

In some embodiments, the one or more purchasing rules of each of the buy matrices includes at least one global rule and at least one vehicle rule for a buying dealer.

In some embodiments, each global rule provides one or more purchasing limits for cumulative purchases across the at least one vehicle rule.

In some embodiments, the one or more purchasing limits are based on at least one of: a total amount of money spent or a total quantity of vehicles purchased.

In some embodiments, the specification of the target vehicle is compared with the at least one vehicle rule in each of the buy matrices. For any buy matrix having a vehicle rule matching the specification of the target vehicle, a determination is made whether the one or more purchasing limits of the at least one global rule corresponding the buy matrix have been fully satisfied. For any buy matrix having the vehicle rule matching the specification of the target vehicle and one or more unsatisfied purchasing limits, the matched offer for the target vehicle is provided.

In some embodiments, more than one buy matrix includes both (i) a vehicle rule matching the specification of the target vehicle and (ii) an unsatisfied purchasing limit. A shipping distance from a location of the target vehicle to a location for each of the more than one buy matrix is determined, and a shipping cost is calculated based on the shipping distance for each of the more than one buy matrix. A matched offer is adjusted based on the shipping cost for each of the more than one buy matrix, and the matched offers are provided to the selling dealer.

In some embodiments, the shipping costs are compared to a maximum shipping cost stored in each of the more than one buy matrix.

Other technical features may be readily apparent to one skilled in the art from the following figures, descriptions, and claims.

### BRIEF DESCRIPTION OF THE DRAWINGS

For a more complete understanding of this disclosure and its advantages, reference is now made to the following description taken in conjunction with the accompanying drawings, in which like reference numerals represent like parts:

FIGS. 1A and 1B illustrate example vehicle trading platform system configurations according to embodiments of this disclosure;

FIG. 2 illustrates an example database structure for a buy matrix according to embodiments of this disclosure;

FIG. 3 illustrates an example sequence diagram for configuring a buy matrix according to embodiments of this disclosure;

FIG. 4 illustrates an example flow diagram for obtaining an offer via a matrix match process according to embodiments of this disclosure;

FIG. 5 illustrates an example flow diagram for selecting an offer to execute an instant vehicle trade according to embodiments of this disclosure;

FIG. 6 illustrates an example flow diagram for selecting a guarantee offer option according to embodiments of this disclosure;

FIG. 7 illustrates an example global rule set interface according to embodiments of this disclosure;

FIGS. 8A and 8B illustrate an example vehicle rule set interface according to embodiments of this disclosure;

FIG. 9 illustrates an example combination vehicle rule set and vehicle specification interface according to embodiments of this disclosure; and

FIG. 10 illustrates an example device implemented with a vehicle trading platform according to this disclosure.

### DETAILED DESCRIPTION

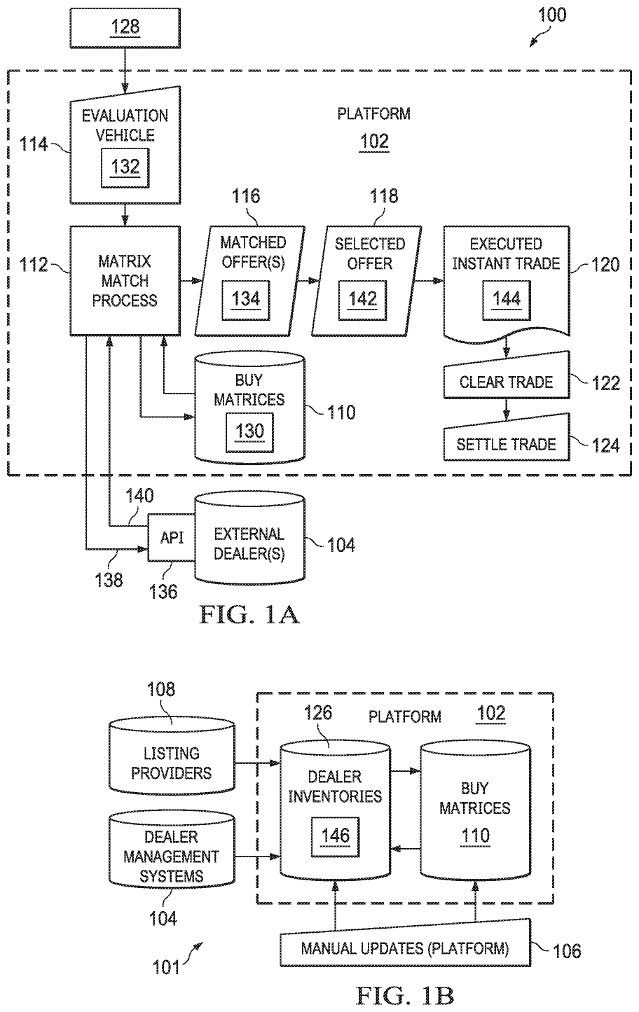

FIGS. 1 through 10, described below, and the various embodiments used to describe the principles of the present invention in this patent document are by way of illustration only and should not be construed in any way to limit the scope of the invention. Those skilled in the art will understand that the principles of the present invention may be implemented in any type of suitably arranged device or system.

This specification relates generally to methods and systems enabling a dealer to match a vehicle that is for sale to vehicles in acquisition plans of other dealers in order to accomplish trades. More specifically, this can be done in a way that optimizes both the vehicle owner's ability to sell the vehicle within a desirable time frame and at a profitable price and the buying dealers' ability to acquire vehicles according to its acquisition plan time frames and pricing. Used vehicle dealers are in the business of acquiring vehicles in order to resell those vehicles at a profit. As part of their business planning, vehicle dealers typically identify and document the types of vehicles that they would like to acquire, the quantity of vehicles to acquire monthly or during some other time period, their budget for acquiring the vehicles, and so forth. While physical auctions have been a common method used by vehicle dealers to fulfill their acquisition plans, many auctions have moved to online platforms with the growth of the Internet. Dealers are able to set up automated searches for vehicles matching their acquisition plans, giving the perception of saving both time and money over attending physical auctions. Unfortunately, the need to pay subscription fees to multiple vehicle trading platforms can result in expenses that are higher than any actual savings. The cost to dealers of online auction subscriptions is compounded by their costs to implement integrations with dealer management systems that can effectively leverage the capabilities of the online vehicle trading platforms. Additionally, as both dealer management systems and online vehicle trading platforms evolve, dealers can incur additional expenses on customizations necessary to keep their systems functioning optimally.

End consumers have been another common source used by vehicle dealers to fulfill their acquisition plans, such as when individual buyers of vehicles have trade-in vehicles. This behavior has also been impacted by the growth of the Internet since consumers typically begin searching for their next vehicles on the Internet, where opportunities are offered to have their current vehicles evaluated online and/or to bring their current vehicles to a dealership for evaluation. Consumers have also come to expect dealerships to make an offer on their current vehicles whether or not they are purchasing replacement vehicles. Dealerships need to be able to respond on-demand to evaluation requests in order to compete successfully.

In addition to vehicle acquisition planning, dealers also identify goals for selling their acquired vehicles in a timely manner in order to minimize carrying costs due to expenses such as interest and vehicle depreciation. For example, vehicles that have been in a dealer's inventory for over 45 days can jeopardize profitability. One difficulty in moving inventory is that vehicle buyers can lack commitment to a purchase offer due to simultaneous negotiations with other dealers or due to a lack of ability to qualify for needed financing. The ability to identify buyers who are both committed to making a purchase and able to pay for it is often important or essential to a dealer's success in moving inventory effectively.

The systems and methods described in this disclosure help to overcome these and other problems by providing an online vehicle trading platform in which dealers on the platform can specify their dealerships' acquisition plans by defining purchase orders in a flexible, scalable data structure (called a “buy matrix”) in a manner that enables the accompanying application (called a “matrix match process”) to evaluate any vehicle available for purchase (called a “target vehicle”). This is accomplished by searching through active buy matrix data of dealers on the vehicle trading platform using an algorithm to translate their buy matrix data into calculable buy offers for the target vehicle and then comparing the offers to identify the most favorable offers to present to the dealer owning the target vehicle as actionable buy offers. The matrix match process can also, based on a configurable option, send bid requests to one or more active external partners who are not dealers on the platform but who are dealers who have an agreement enabling them to receive a bid request for a target vehicle via an application programming interface (“API”), submit it to their internal systems for evaluation, and respond to the bid request with a buy offer or a no-bid response. A buy offer from an external partner can be forwarded by the matrix match process as a matched offer for comparison against any other buy offer(s) for the target vehicle and, if sufficiently favorable, presented to the dealer owning the target vehicle as an actionable buy offer.

Note that the buy offers described above are actionable in the sense that if the dealer owning the target vehicle selects one of them, an instant trade is executed. Before having an account activated on the vehicle trading platform, each dealer can provide evidence of its ability to pay for vehicle purchases fulfilled via the vehicle trading platform and can provide automatic access to the dealership's funding, such as in the form of automatic clearing house (“ACH”) information, dealership credit line (“Floorplan”) financing, or other means of automated funding. In the event that funding issues occur with a dealer, the vehicle trading platform is able to deactivate the dealer's buy matrix so that it will no longer be able to be considered for or present buy offers. Similarly, external partners can provide evidence of their ability to fund vehicle purchases, and bid requests to that external partner via the API can be suspended if funding issues subsequently occur.

With the online vehicle trading platform, a selling dealer's risk of failed negotiations or financing is virtually eliminated. Also, the buying dealer's risk of unfulfilled acquisition plans is significantly minimized by leveraging a network of dealers posting inventory on the vehicle trading platform to be regularly and automatically compared to the buying dealer's buy matrix, and the buying dealers can adjust their offers as needed to be more competitive. Each buying dealer's buy matrix also provides built-in protection against the risk of exceeding vehicle budget plans or vehicle quantity plans or overstocking a particular type of vehicle, such as by enabling the buying dealer to set limits on both spending and quantity at several levels of the buy matrix's data structure.

The vehicle trading platform also enables vehicle dealers to create limit orders to buy vehicles. Each dealer can update its buy matrix to include a purchase order for a certain vehicle specification, a maximum quantity of vehicles to buy matching the vehicle specification, a calculable offer price at which the buying dealer agrees that the order will be executed, and a time period in which the order will be active. While the order is active, the vehicle trading platform can identify a target vehicle that matches the order and automatically present a buy offer for the vehicle. If the selling dealer selects the buy offer, the trade is instantly executed. The vehicle trading platform further enables vehicle dealers to purchase put options. For example, each dealer can pay a fee for the right to sell a target vehicle on a future date (the expiration date) at a predetermined price. During the period between purchasing the put option and its expiration date, a dealer cannot exercise the option but can continue to receive buy offers via the vehicle trading platform and choose to execute one of those offers. If the dealer still owns the vehicle on the specified expiration date and does not exercise the option to sell at the predetermined price, the option expires.

Overall, this disclosure provides systems and methods for maintaining vehicle acquisition plans of dealerships in database structures referred to as buy matrices, possibly in a trade-ready format. The systems and methods enable a dealer to submit a vehicle with its full specifications as a target vehicle to a matrix match process, which compares the target vehicle specifications against the specifications in the buy matrices to identify the best matches (offers) and may, based on configuration, forward the target vehicle specifications to one or more external partners to solicit offers. The systems and methods enable the matrix match process to identify the best matched offer(s) to present on the target vehicle for the vehicle seller to review and select an offer. The systems and methods also enable the selection of an offer to trigger an executed instant trade.

FIGS. 1A and 1B illustrate example vehicle trading platform system configurations 100 and 101 according to embodiments of this disclosure. In particular, FIG. 1A illustrates an example matrix match system configuration 100 for a vehicle trading platform 102, and FIG. 1B illustrates an example data update and synchronization system configuration 101 for the vehicle trading platform 102. The embodiments of the vehicle trading platform system configurations 100 and 101 illustrated in FIGS. 1A and 1B are for illustration only. FIGS. 1A and 1B do not limit the scope of this disclosure to any particular implementation of a vehicle trading platform system configuration.

As shown in FIGS. 1A and 1B, the matrix match system configuration 100 can be used to perform a vehicle transaction between two dealerships and includes a vehicle trading platform 102. Also, the data update and synchronization system configuration 101 can be used to perform data updates and synchronizations involving the vehicle trading platform 102. In this example, the vehicle trading platform 102 may be used in conjunction with one or more external dealership management systems 104, an administration system 106, and one or more listing provider systems 108. Note that the vehicle trading platform 102 may be used in conjunction with any suitable numbers of these systems 104, 106, 108.

The vehicle trading platform 102 can receive vehicle information from at least one seller dealership and find optimal offers from platform buyer dealerships, external dealerships, independent listing services, etc. The vehicle trading platform 102 includes one or more buy matrix databases 110, a matrix match algorithm 112, an evaluation vehicle algorithm 114, a matched offer algorithm 116, a selected offer algorithm 118, an executed instant trade algorithm 120, a clear trade algorithm 122, a settle trade algorithm 124, and one or more dealer inventory databases 126. Each of the algorithms 112-124 can be implemented in any suitable manner, such as by using software instructions that are executed by one or more processors.

The buy matrix database 110 stores one or more buy matrices 130 for each of the member dealerships. Each buy matrix 130 represents a data structure that contains one or more rules for making purchases of vehicles. The rules can include global rules and local rules as described below. Each buy matrix 130 can store any suitable number of global rules and local rules. Also, each dealership can have one or more than one buy matrix 130 stored in the buy matrix database 110.

The matrix match algorithm 112 can attempt to match each vehicle posted for sale with an optimal purchase price from offers identified using the buy matrices 130 in the buy matrix database 110 and from external dealership management systems 104. For example, the matrix match algorithm 112 can traverse the buy matrix database 110 for buy matrices 130 that include rules referring to a specific vehicle posted for sale. The buy matrix database 110 can provide the buy matrices 130 to the matrix match algorithm 112 for determining the highest offer for purchase on the vehicle posted for sale, and the matrix match algorithm 112 can identify one or more top matches from the buy matrix database 110.

The evaluation vehicle algorithm 114 can receive a target vehicle 128 for evaluation. The target vehicle 128 could represent a vehicle in a dealer's inventory or a vehicle for which a consumer has requested an offer from the dealer (which is referred to as a “fresh trade” vehicle). The evaluation vehicle algorithm 114 can determine details, such as make, model, etc., in a specification 132 about the target vehicle 128 and provide the specification 132 to the matrix match algorithm 112. The target vehicle 128 with its full specification 132 can be forwarded to the matrix match algorithm 112, and the details in the specification 132 about the target vehicle 128 can be matched to details in the rules of the buy matrices 130.

The matched offer algorithm 116 can present one or more matched offers 134 to the selling dealership corresponding to the target vehicle 128. For example, the matrix match algorithm 112 can perform real-time analysis to validate top matches, sometimes eliminating one or more of them, before confirming the most favorable subset of top matches as the matched offer(s) 134 to be presented by the matched offer algorithm 116.

Based on configuration settings, the matrix match algorithm 112 can also forward the retrieved specification 132 of the target vehicle 128 to an external dealer API 136 of an external dealership management system 104 as a bid request 138. Upon receipt of a bid response 140, the matrix match algorithm 112 can determine whether the external dealership management system 104 has returned a “no bid” or an “offer” and, if it is an offer, whether the offer should be added to the matched offer(s) 134.

The selected offer algorithm 118 can receive a selected offer 142 from the subset of top matched offers 134 presented by the matched offer algorithm 116. For example, multiple matched offers 134 for the target vehicle 128 can be presented and reviewed by the selling dealer, and the selling dealer can identify and accept the selected offer 142. In other words, one of the matched offers 134 can be selected by the dealer selling the target vehicle 128.

The executed instant trade algorithm 120 can execute an instant trade 144 between the selling dealership and the purchasing dealership. For example, the selected offer 142 can initiate the executed instant trade algorithm 120, and the executed instant trade 144 binds the selling dealer and the purchasing dealer into a purchase or trade of the target vehicle 128. The clear trade algorithm 122 can perform operations for clearing a trade. For instance, the clear trade algorithm 122 can check title to ensure the ability of the target vehicle 128 to be sold. The settle trade algorithm 124 can perform operations for finalizing a trade. For example, the settle trade algorithm 124 can initiate a transport order, transfer funds, etc.

A dealer inventory database 126 can interact with one or more external dealership management systems 104 and/or one or more listing provider systems 108 to update dealer inventories 146 stored on the vehicle trading platform 102. This may allow, for example, the dealer inventories 146 in the dealer inventory database 126 to be compared to the buy matrices 130 in the buy matrix database 110. As a result, the vehicle trading platform 102 can also identify offers that can be accepted by other dealers based on the dealer inventories 146 in the dealer inventory database 126.

The vehicle trading platform 102 can support automatic data synchronization of the dealer inventory database 126 and the buy matrix database 110. During a typical business day, for example, updates can be made to data in the external dealership management systems 104 of dealers using the platform 102, as well as to data in listing provider systems 108. On a scheduled basis, such as once nightly and/or at other times as needed, a data feed can be used to pull updates from external dealership management systems 104 and listing provider systems 108 into the dealer inventory database 126 in order to synchronize the dealer inventories 146. Some of the auto-feed updates may trigger auto-updates to related data in buy matrices 130 in the buy matrix database 110 corresponding to a dealer, such as fulfilled quantities and spends for vehicles acquired by dealers on the vehicle trading platform 102. Auto-updates can also be made to dealer inventories 146 by the buy matrices 130 as the matrix match algorithm 112 is invoked on a scheduled basis to generate offers that are then presented on vehicles in inventory, either as new offers or refreshed offers before they become stale.

Manual updates can be made directly in the dealer inventory database 126 and buy matrix database 110 from a variety of devices via the administration system 106, such as laptop or desktop computers, tablet computers, and mobile devices. Examples of manual updates to the dealer inventories 146 can include configuration changes, such as configuring a feature like a 45-day guarantee policy, and on-demand requests to get offers on a target vehicle 128, which could be a vehicle in the dealer's current inventory or a fresh trade vehicle. Manual updates can also be made to the buy matrices 130 in the buy matrix database 110 on the vehicle trading platform 102 to configure rules, settings, and specifications for the dealer's vehicle acquisition plans.

Although FIGS. 1A and 1B illustrate examples of vehicle trading platform system configurations 100 and 101, various changes may be made to FIGS. 1A and 1B. For example, the matrix match system configuration 100 may support any number of buy matrix databases 110 and be used in conjunction with any suitable number(s) and type(s) of external applications or systems. As noted above, the examples of the external applications or systems used with the vehicle trading platform system configurations 100 and 101 in FIGS. 1A and 1B are for illustration only.

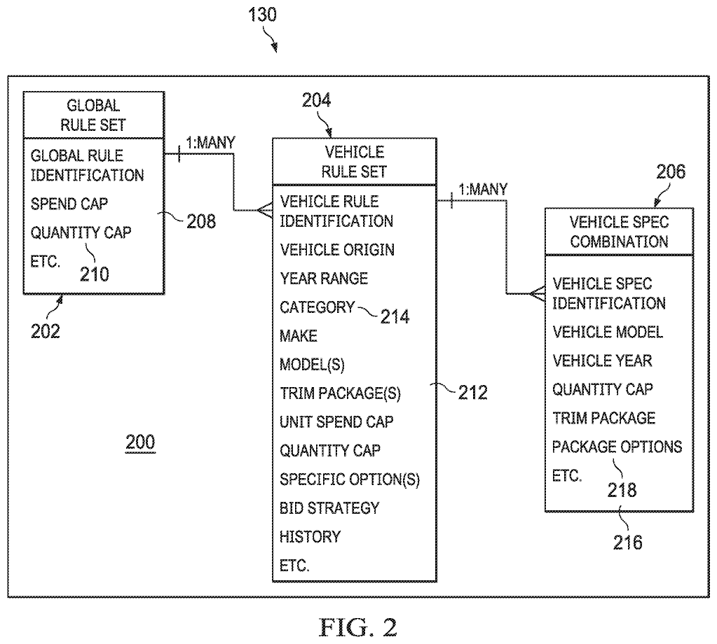

FIG. 2 illustrates an example database structure 200 for a buy matrix 130 according to embodiments of this disclosure. The embodiment of the database structure 200 illustrated in FIG. 2 is for illustration only. FIG. 2 does not limit the scope of this disclosure to any particular implementation of a buy matrix database.

As shown in FIG. 2, an entity relationship diagram showing the database structure 200 of a dealer's buy matrix 130 on the vehicle trading platform 102 provides the dealer's vehicle acquisition specifications in a structured format that can be processed by the matrix match algorithm 112. The three entities within the buy matrix 130 include a global rule set 202, a vehicle rule set 204, and a vehicle spec combination 206.

Given any selling dealer's target vehicle 128, the matrix match algorithm 112 searches the buy matrix database 110 on the vehicle trading platform 102 to identify acquisition matches based on the target vehicle's specification 132, evaluates each match based on acquisition rule data, and calculates an offer price for each remaining match based on a documented preconfigured bid strategy. The matrix match algorithm 112 also refines the list of matches to include only the top matches, where the quantity of top matches is a configurable value. Based on the configuration of the vehicle trading platform 102, the matrix match algorithm 112 can submit the specification 132 of the target vehicle 128 in a bid request 138 to one or more external dealership management systems 104 and, if an offer is returned, compare the external offer to the list of top matches and determine whether to include the external offer in the list. The top matches can then be presented as matched offers 134.

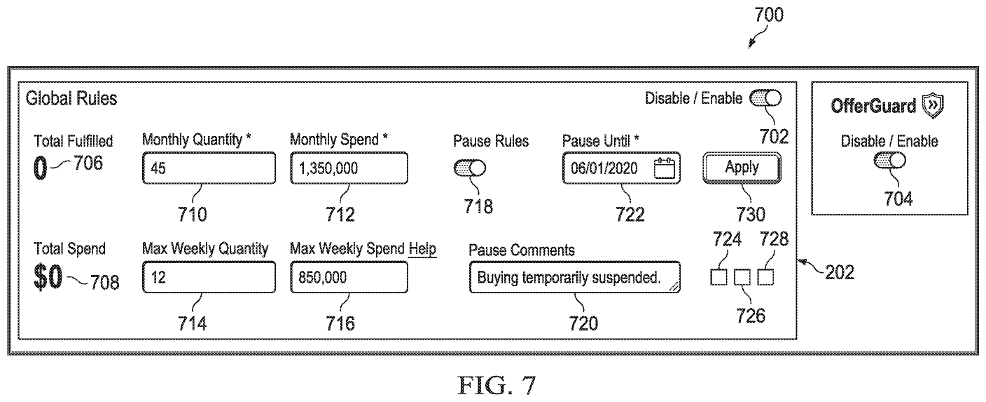

In FIG. 2, the database structure 200 for the buy matrix 130 includes the global rule set 202, the vehicle rule set 204, and the vehicle spec combination 206. In some embodiments, each buy matrix 130 contains a single global rule set 202, one or more vehicle rule sets 204, and one or more vehicle spec combinations 206. The global rule set 202 can include one or more global rules 208 and one or more global settings 210 applicable at a global level of the buy matrix 130. For example, one or more global rules 208 can be used to enable or disable particular features offered by the dealership or to temporarily pause all vehicle purchases for a specified period of time, such as due to some unforeseen event (like a tornado or pandemic). One or more global settings 210, such as spending caps and quantity caps for specified time periods, can be configured for budget considerations. The global rule(s) 208 and global setting(s) 210 in the global rule set 202 can take precedence over rules and settings in the associated vehicle rule set(s) 204. Specific examples of global rules 208 and global settings 210 are discussed below with respect to FIG. 7.

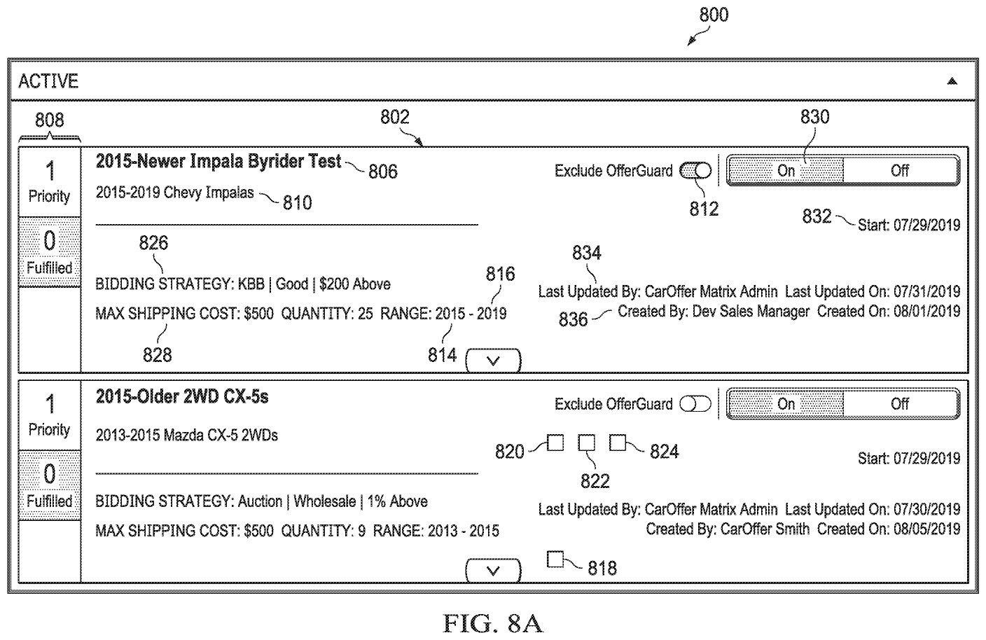

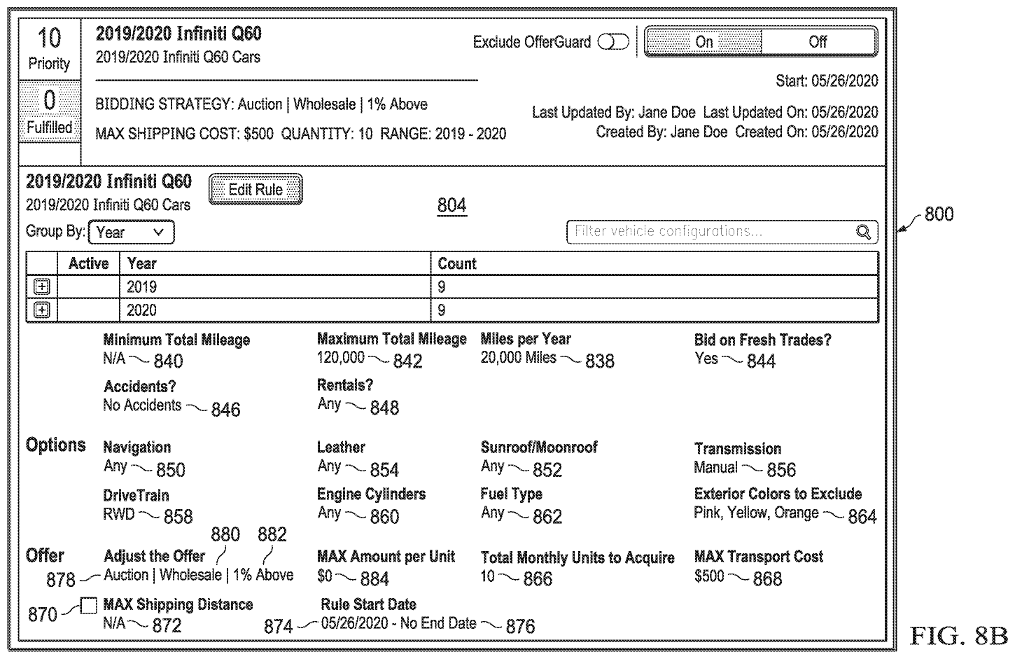

Each vehicle rule set 204 includes one or more vehicle rules 212 that are valid in the context of that vehicle rule set 204 only. Each vehicle rule set 204 also includes one or more vehicle attributes 214, which define one or more attributes of vehicles associated with the vehicle rule set 204. The global rules 208 and global settings 210 in the global rule set 202 take precedence over the vehicle rules 212 and the vehicle attributes 214 in the vehicle rule set 204. Specific examples of vehicle rule sets 204 are discussed below with respect to FIGS. 8A and 8B.

Each vehicle spec combination 206 provides additional customizations for specific combinations 216 of attributes 218 for a target vehicle 128. For example, the attributes 218 can be selected for different specification combinations 216 for further customization of a vehicle rule set 204.

Although FIG. 2 illustrates one example of a database structure 200 for a buy matrix 130, various changes may be made to FIG. 2. For example, a buy matrix 130 may include any suitable information arranged in any suitable manner and is not limited to the specific database structure 200 shown in FIG. 2.

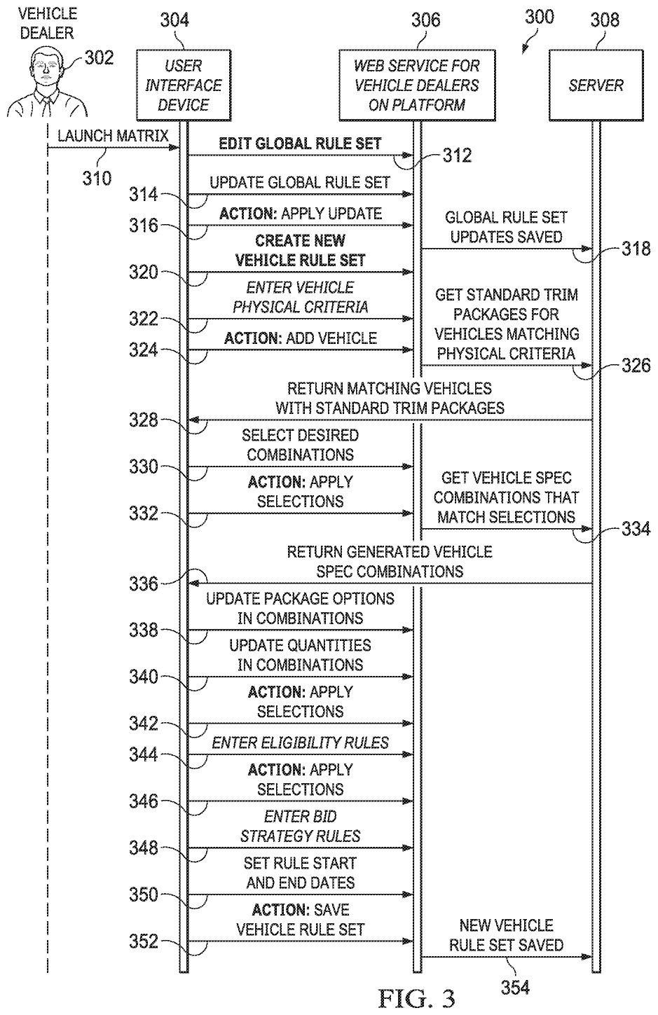

FIG. 3 illustrates an example sequence diagram 300 for configuring a buy matrix 130 according to embodiments of this disclosure. For ease of explanation, the sequence diagram 300 illustrated in FIG. 3 may be described as involving the use of the vehicle trading platform 102, the external dealership management systems 104, and the administration system 106 of FIGS. 1A and 1B. However, the sequence diagram 300 may involve the use of any suitable device(s) in any suitable system.

As shown in FIG. 3, the sequence diagram 300 shows a high-level process to configure a dealer's buy matrix 130. The sequence diagram 300 shows a vehicle dealer 302, a buy matrix user interface 304 that could be the external dealership management system 104 or administration system 106, a web service 306 for the vehicle dealer 302 on the vehicle trading platform 102, and a server 308 on which the vehicle trading platform 102 can be stored.

The vehicle dealer 302 can launch a buy matrix generation process using the buy matrix user interface 304 in step 310. For example, the launching of the matrix generation process can be performed on the administration system 106. In some embodiments, when a dealer's account on the vehicle trading platform 102 is first established, it can include an initial configuration for the global rule set 202. Thus, in these embodiments, the global rule set 202 may not require any initial vehicle rule set 204 to be preconfigured. The preconfigured global rule set 202 can be manually updated as needed from the user interface 304, such as a laptop or desktop computer, tablet computer, or mobile device. The buy matrix user interface 304 can transmit a message to the web service 306 indicating that the global rule set 202 is going to be edited in step 312. The buy matrix user interface 304 can transmit a message with an updated global rule 208 to the web service 306 in step 314. The user interface 304 can transmit a message to apply or confirm the updated rule set in step 316. These steps 312-316 can be performed sequentially or be combined into a single message. The web service 306 can process the message or messages sent in steps 312-316 and transmit a message with the update global rule set 202 to the server 308 in step 318.

The sequence for creating a new vehicle rule set 204 from the user interface 304 may be more involved than the sequence for updating the global rule set 202 in steps 312-318. To create a new vehicle rule set 204, the user interface 304 transmits a message indicating creation of a new vehicle rule set 204 to the web service 306 in step 320. The vehicle dealer 302 can enter one or more vehicle attributes 214 in at least one vehicle rule 212, which the buy matrix user interface 304 transmits to the web service 306 in step 322. The vehicle dealer 302 can also confirm the new vehicle rule set 204 through the user interface 304 at step 324. Steps 320-324 can be performed sequentially or be combined into a single message. The web service 306 processes the message(s) from steps 320-324 and submits a request to the server 308 to obtain a grid showing vehicle models valid for the physical criteria with a complete list of trim or package options for those vehicles in step 326. The server 308 can return matching vehicles with trim packages either directly to the buy matrix user interface 304 or to the buy matrix user interface 304 through the web service 306 in step 328.

The buy matrix user interface 304 can provide a selection of desired combinations from a user to the web service 306 in step 330. The buy matrix user interface 304 can indicate an action to be applied to the selections by the web service 306 in step 332. The selected combinations are submitted as a request to the server 308 to obtain a complete set of fully-specified vehicle spec combinations 206 in step 334, where each combination can be customized with respect to package options and maximum quantity of that combination to acquire per month. The server 308 can return generated vehicle spec combinations 206 to the buy matrix user interface 304 in step 336.

The user interface 304 can send an indication to update a package option in one or more combinations to the web service 306 in step 338, provide one or more updated quantities for the combinations in step 340, and indicate an action to apply to the selection of combinations in step 342. Messages sent from the buy matrix user interface 304 to the web service 306 in steps 338-342 can be performed sequentially or be combined into a single message. The user interface 304 can also send entered eligibility rules for prospective vehicles to acquire to the web service 306 in step 344 and an indication to apply the selection of the eligibility rules in step 346. The messages sent from the buy matrix user interface 304 to the web service 306 in steps 344-346 can be performed sequentially or be combined into a single message.

Finally, a bid strategy can be configured with both rules or settings to potentially eliminate some prospective vehicles and parameters that enable the calculation of an offer price for any prospective vehicle in steps 348-352. For example, the buy matrix user interface 304 can indicate that new bid strategy rules are going to be entered in step 348, provide the rules' start and end dates in step 350, and indicate to save a new vehicle rule set 204 in step 352. Once the web service 306 has received the indication to save the new vehicle rule set 204, the web service 306 forwards the new vehicle rule set 204 to be saved on the server 308 in step 354.

Although FIG. 3 illustrates one example of a sequence diagram 300 for configuring a buy matrix 130, various changes may be made to FIG. 3. For example, the sequence diagram 300 may be used to communicate with more than one external dealer system. Also, the specific ordering of messages in FIG. 3 is for illustration only and can easily vary based on the specific operations being initiated by the vehicle dealer 302.

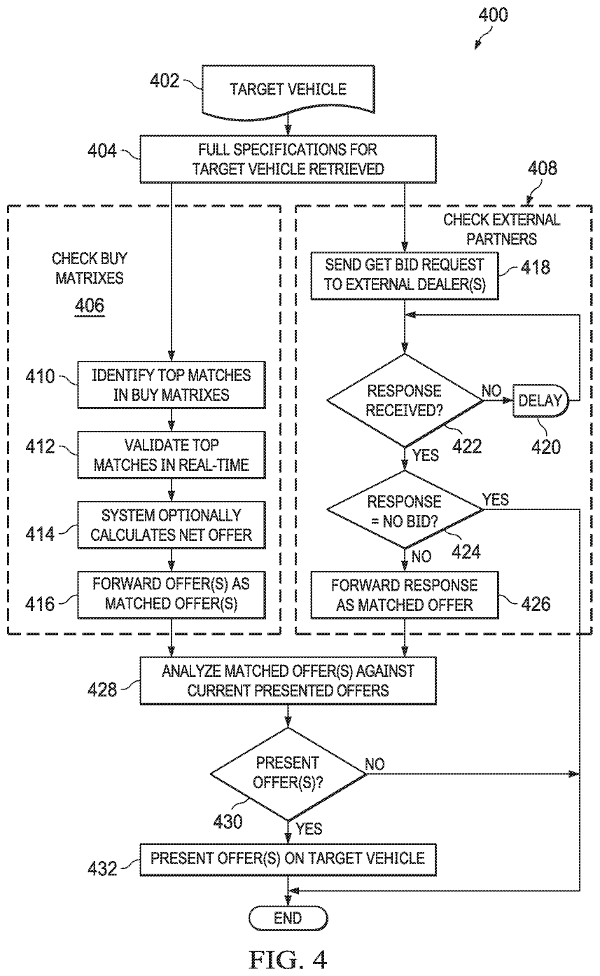

FIG. 4 illustrates an example flow diagram 400 for obtaining an offer via a matrix match process according to embodiments of this disclosure. For ease of explanation, the flow diagram 400 illustrated in FIG. 4 may be described as involving the use of the vehicle trading platform 102, the external dealership management systems 104, and the administration system 106 of FIGS. 1A and 1B. However, the flow diagram 400 may involve the use of any suitable device(s) in any suitable system.

As shown in FIG. 4, the vehicle trading platform 102 is initiated upon receipt of a request to obtain offers for a dealer's target vehicle 128 in step 402. In some embodiments, the request can be provided from a seller dealership through a user interface 304. In other embodiments, the request can be automatically issued according to a configured schedule. The request can include the vehicle trading platform 102 reviewing a dealer's inventory to generate matched offers for vehicles in the dealer's inventory.

The vehicle trading platform 102 retrieves vehicle specification 132 in step 404. The vehicle specification 132 can include data related to the target vehicle 128, including data derived from its Vehicle Identification Number (“VIN”). The vehicle specification 132 can be received through one or multiple sources, such as an on-board computer of the target vehicle 128, a seller's database, a seller's manual input, and third-party sources such as an accident tracking service. Once the vehicle specification 132 is received, the vehicle trading platform 102 initiates a check buy matrix sub-process 406 and check external partners sub-process 408. The check buy matrix sub-process 406 involves member dealers that have each created a buy matrix 130, and the check external partners sub-process involves communicating target vehicle information to and receiving offers from external dealerships.

As part of the check buy matrix sub-process 406, the vehicle trading platform 102 compares the specification 132 of the target vehicle 128 against the vehicle acquisition plans of other dealers specified in their buy matrices 130 as preconfigured purchase orders so that a set of top matches can be identified in step 410. In some cases, the quantity of top matches to identify is configurable. The vehicle trading platform 102 performs validation of the top offers in step 412. The validation can occur in real-time to ensure that the offers are based on valuation data that is fresh, and considers each buying dealer's location. The real-time validation also ensures that the buying dealer's acquisition plan and bid strategy as documented in the applicable global rule set 202, vehicle rule set 204, and vehicle spec combinations 206 of the buy matrix 130 are current (since all can be subject to regular updating). The vehicle trading platform 102 can optionally calculate a net offer in step 414. In some embodiments, such as when there is difficulty in identifying any favorable matches for a target vehicle 128 and a buying dealer's buy matrix 130, the vehicle trading platform 102 may be able to provide a favorable match if the bid strategy in the vehicle rule set 204 of the buying dealer's buy matrix 130 had a higher value for maximum transport cost. The vehicle trading platform 102 can calculate a net offer in which an excess transport cost is subsidized by making a corresponding reduction to the offer price originally calculated based on the bid strategy in the buying dealer's buy matrix 130. The platform 102 can maintain an internal value for maximum shipping distance that cannot be exceeded even for the purposes of calculating a net offer in order to minimize its own risk of expenditure to return a purchased vehicle in the event of a subsequent arbitration that cancels the purchase for a reason such as misrepresentation of the condition of the target vehicle 128. The remaining validated list of top matches is further refined by selecting only the top subset to forward as matched offers 134 in step 416. Again, in some cases, the quantity of top matched offers 134 in the subset to forward is configurable.

As part of the check external partners sub-process 408 (which is optional), the platform 102 can submit at least one bid request 138 to one or more cooperating external dealership management systems 104 in step 418. The vehicle trading platform 102 can determine whether at least one bid response 140 is received in step 422. Each bid response 140 can include an offer or a rejection. A delay can be implemented if and when a bid response 140 has not been received by the vehicle trading platform 102 in step 420. The delay can be based on a predetermined amount of time for allowing the external partner to respond to the bid request 138. The delay can be used to interpret the lack of received response as a “no bid” response. The vehicle trading platform 102 can determine whether a “no bid” was indicated by each bid response 140 in step 424. If an offer is not received in any bid responses 140, the matrix match algorithm 112 does not generate an automatic offer on the target vehicle 128 from any external partners. If at least one offer is received in the bid response 140, the at least one offer is forwarded as at least one matched offer 134 in step 426.

Any matched offers 134 (from either the check buy matrix sub-process 406 or the check external partners sub-process 408) are analyzed by comparing them with any offer(s) currently presented on the target vehicle 128 in step 428. The analysis can reduce the amount of automatic offers or merely organize the offers based on, for example, monetary value. The vehicle trading platform 102 can determine whether to present any matched offers 134 in step 430. For example, the selling dealer may have set a minimum price of the target vehicle 128, so any offers below the minimum price would not be presented. Any matched offer 134 can be presented in place of an existing offer or in addition to existing offer(s) on the target vehicle 128 in step 432. Any offer presented on the target vehicle 128 is an actionable buyer offer, which means that the selling dealer accepting one of the presented offers by selecting it constitutes bilateral acceptance and forms an executed instant trade 144.

Although FIG. 4 illustrates one example of a flow diagram 400 for obtaining an offer via a vehicle trading platform 102, various changes may be made to FIG. 4. For example, while shown as a series of steps, various steps in FIG. 4 may overlap, occur in parallel, occur in a different order, or occur any number of times.

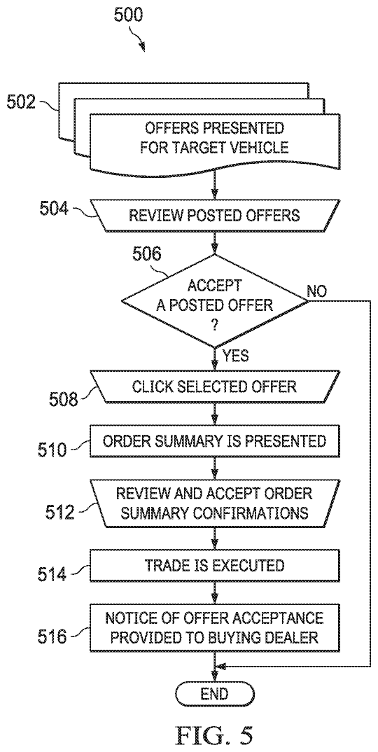

FIG. 5 illustrates an example flow diagram 500 for selecting an offer to execute an executed instant vehicle trade according to embodiments of this disclosure. For ease of explanation, the flow diagram 500 illustrated in FIG. 5 may be described as involving the use of the vehicle trading platform 102, the external dealership management systems 104, and the administration system 106 of FIGS. 1A and 1B. However, the flow diagram 500 may involve the use of any suitable device(s) in any suitable system.

As shown in FIG. 5, the vehicle trading platform 102 receives offers on a target vehicle 128 in step 502. For example, the matrix match algorithm 112 can provide automatically-generated offers based on settings selected by the selling dealer. As a particular example, the selling dealer could select a minimum price for a target vehicle, and the matrix match algorithm 112 may provide automatically-generated offers that are at or above the minimum price. The vehicle trading platform 102 can display the offers for review by the selling dealer in step 504. In some cases, the offers can be presented as individual offers for a number of target vehicles 128 posted by the selling dealer or multiple offers for a single target vehicle 128. Each offer can include an option to accept and automatically execute the trade.

The vehicle trading platform 102 can determine whether a posted offer is not accepted in step 506. If an offer is not currently accepted, the vehicle trading platform 102 can leave the offer for review and automatically update the offer based on other transactions occurring on the vehicle trading platform or updates to the buy matrix 130 corresponding to the posted offer. If the offer has an amount of time to accept, the vehicle trading platform 102 can cancel the generated offer when the time period ends.

If the dealer decides to accept one of the presented offers, the dealer can click or otherwise indicate acceptance of the offer, which is received by the vehicle trading platform 102 in step 508. The vehicle trading platform 102 can automatically pre-process the selected offer 142 to generate an order summary, and the order summary for the selected offer 142 is presented for the dealer to review in step 510. The order summary can provide more details than the overview of the initial offer, such as by including shipping costs, shipping location, etc. Once the dealer approves the order summary as well as any additional confirmations that may be presented, the vehicle trading platform 102 receives an order summary confirmation in step 512. The order summary confirmation initializes the execution of the trade, and the vehicle trading platform 102 executes the trade in step 514. The executed instant trade 144 is generated, and both parties are held to the contract that is created. A notification of offer acceptance is provided to the applicable buying dealer in step 516, thereby completing the trade execution.

Although FIG. 5 illustrates one example of a flow diagram 500 for selecting an offer for an executed instant trade 144, various changes may be made to FIG. 5. For example, while shown as a series of steps, various steps in FIG. 5 may overlap, occur in parallel, occur in a different order, or occur any number of times.

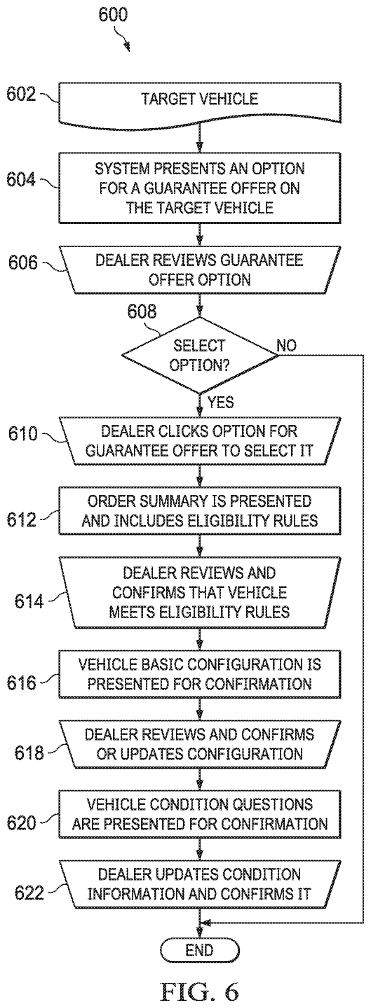

FIG. 6 illustrates an example flow diagram 600 for selecting a guarantee offer option in accordance with this disclosure. For ease of explanation, the flow diagram 600 illustrated in FIG. 6 may be described as involving the use of the vehicle trading platform 102, the external dealership management systems 104, and the administration system 106 of FIGS. 1A and 1B. However, the flow diagram 600 may involve the use of any suitable device(s) in any suitable system.

As shown in FIG. 6, the vehicle trading platform 102 receives a target vehicle 128 in step 602. A seller dealership can provide a specification 132 for a target vehicle 128 to the vehicle trading platform 102. The vehicle trading platform 102 can present a guarantee offer option on the target vehicle 128 in step 604. In some embodiments, the platform can pre-calculate a future purchase price for the target vehicle 128 and present the offer option as a guarantee offer option to sell the vehicle at a future date (“Expiration Date”) for the pre-calculated purchase price. The dealer can review the guarantee offer option in step 606 to evaluate whether or not the fee associated with purchasing the option is reasonable based on the protection it offers against the possibility of the particular target vehicle 128 going stale in inventory. The vehicle trading platform 102 can determine whether a guarantee offer option is selected in step 608. If the dealer decides to select the option, then the dealer provides that selection to the vehicle trading platform 102 in step 610.

The vehicle trading platform 102 receives a dealer selection of the option for the guarantee offer in step 610. The vehicle trading platform 102 can automatically pre-process the offer to generate an order summary including eligibility rules for the guarantee offer. The vehicle trading platform 102 presents the order summary including the eligibility rules to the matrix user interface 304. The eligibility rules can be emphasized on the user interface or can have a special prompt to ensure that the eligibility rules are properly displayed to the user. A series of confirmations is displayed to ensure that the dealer understands the guarantee offer eligibility rules and confirms that the target vehicle 128 is eligible in step 614. The eligibility rules can include certain conditions for receiving the guarantee offer.

The vehicle trading platform 102 can present the basic configuration for the target vehicle 128 for confirmation in step 616. The basic configuration for the target vehicle 128 can be generated based on the received specification 132. The dealer can provide an update or correction to the vehicle trading platform 102 before confirming the configuration in step 618. The basic configuration presented to the dealer can include an edit option for each entry. Upon selecting the edit option, a component of the basic configuration is editable. In order to continue, a specific condition questionnaire regarding the presence of any blemishes on its vehicle history reports, the presence of any structural damage, substantial body damage, mechanical/electrical issues, or the presence of any aftermarket parts are accurately answered in step 620. The specific condition questionnaire can be filled out electronically or uploaded. The vehicle trading platform 102 receives updated condition information indicating that the dealer certifies the confirmations and clicks to confirm the purchase of the guarantee offer option in step 622. The vehicle trading platform can present the updated condition information on the user interface 304.

Although FIG. 6 illustrates one example of a flow diagram 600 for selecting a guarantee offer option, various changes may be made to FIG. 6. For example, while shown as a series of steps, various steps in FIG. 6 may overlap, occur in parallel, occur in a different order, or occur any number of times. One example of the steps occurring in a different order is when a dealer elects to establish a Guarantee Offer Policy, which will select the guarantee offer option per step 610 automatically for every eligible inventory vehicle, enabling the selling dealer to perform the offer review step 606 afterwards, retaining the right to cancel purchase of the option within a configured grace period.

FIG. 7 illustrates an example global rule set interface 700 according to embodiments of this disclosure. The global rule set interface 700 can be implemented in the buy matrix user interface 304 shown in FIG. 3 in order to define at least one global rule set 202. The embodiment of the global rule set interface 700 illustrated in FIG. 7 is for illustration only. FIG. 7 does not limit the scope of this disclosure to any particular implementation of a vehicle trading platform.

As shown in FIG. 7, the global rule set interface 700 can be used to flexibly define global rules 208 and global settings 210 in a global rule set 202, such as by adding new rules as needed or desired or by retiring rules that may become outdated. Examples of attributes for global rules 208 and global settings 210 can include a global rule setting 702, a special feature setting 704, a total fulfilled amount 706, a total spent amount 708, a monthly quantity 710, a monthly spend amount 712, a maximum weekly quantity 714, a maximum weekly spend amount 716, a global rule pause 718, a comments pause 720, a pause until date 722, states-to-exclude list 724, a dealers selection 726, a dealer include/exclude list 728, etc. The global rule set interface 700 can further include an apply button 730.

The global rule setting 702 can be a toggle switch to control the active state of the rules in a buy matrix 130. By default, when a new dealer is configured, this buy matrix rule can be set to disable so that the buy matrix 130 can be fully configured before the account goes live. The special feature setting 704 can be a toggle switch to control the active state of a special feature. The special feature can be referred to as OFFERGUARD, which can be a fee-based feature to protect buying dealers from the issue of having vehicles go stale in their inventory. When a dealer chooses to enable this special feature in the global rule 208, it is automatically applied to any vehicle the dealer purchases via the vehicle trading platform 102 unless a vehicle rule set 204 overrides the setting by excluding the special features setting on that vehicle rule set.

The total fulfilled amount 706 can be an auto-calculated amount of target vehicles that have been automatically purchased via the buy matrix 130. This setting can auto-calculate the total quantity of vehicles purchased month-to-date or some other configurable time period. The total spent amount 708 can be an auto-calculated amount of money spent on target vehicles that have been automatically purchased via the buy matrix 130. This setting can auto-calculate the total dollar volume (spend) of vehicles purchased month-to-date or some other configurable time period. The monthly quantity 710 can be an integer value entered to indicate a maximum quantity of target vehicles to be purchased under the global rule set 202. A quantity cap for total purchases can be for a calendar month, a 30-day period, or any other suitable time period. The monthly spend amount 712 can be a currency value entered to indicate a maximum spending cap of target vehicles to be purchased under the global rule set 202. A quantity cap for total spending can be for a calendar month, a 30-day period, or any other suitable time period. The maximum weekly quantity 714 can be an integer value entered to indicate a maximum quantity of target vehicles to be automatically purchased under the global rule set 202. A quantity cap for total purchases can be for a calendar week or for any 7-day period. The maximum weekly spend amount 716 can be a currency value entered to indicate a maximum spending cap of target vehicles to be automatically purchased under the global rule set 202. A quantity cap for total spending can be for a calendar week or any 7-day period.

The global rule pause 718 is a setting to enable or disable the global rule 208. Because this is at the global level, setting this value to “on” will pause all vehicle searches and purchases. The comments pause 720 is a text input for indicating the reason for pausing the purchases. The comments pause 720 can have a default text input when the global rule pause 718 is activated. For example, the comments pause 720 can automatically provide a “n/a” or the comments from the previous time the global rule pause 718 was activated. The user can update the comments pause 720 at any time. The pause until date 722 is a setting for a date to indicate when the global pause will automatically end. The pause until date 722 can have a default value or be adjusted to pause a similar amount of time from the previous time the global rule pause 718 was activated. The user can update the value of the pause until date 722 at any time.

The states-to-exclude list 724 is a list that defines states or other locations to exclude from the target vehicle searches. For example, dealers in states with warm climates may not be interested in buying from states where vehicles may be adversely affected by cold weather conditions, such as exposure to road salt. The list can be a drop-down list or any other form of displaying a list. The dealer selection list 726 is a multi-select pick list for indicating dealers to include or exclude when evaluating matches. Configuring a list of dealers with the dealer include option is useful for a dealer group, where the associated dealers want to trade exclusively among themselves. The dealer include/exclude list 728 is a checkbox for indicating whether the dealer selection 726 identifies dealers to include or exclude. The apply button 730 confirms the settings in the global rule set interface 700. Activating the button causes the buy matrix user interface 304 to update the buy matrix 130 on the vehicle trading platform 102.

Although FIG. 7 illustrates one example of a global rule set interface 700, various changes may be made to FIG. 7. For example, the global rule set interface 700 may support any number of global rules and global settings and be used in conjunction with any suitable number(s) and type(s) of external applications or systems.

FIGS. 8A and 8B illustrate an example vehicle rule set interface 800 according to embodiments of this disclosure. In particular, FIG. 8A illustrates an example vehicle rule set interface 800 in headers 802, and FIG. 8B illustrates an example vehicle rule set interface 800 with an expanded header 804. The vehicle rule set interface 800 can be implemented in the buy matrix user interface 304 shown in FIG. 3 in order to define at least one vehicle rule set 204. The embodiment of the vehicle rule set interface 800 illustrated in FIGS. 8A and 8B is for illustration only. FIGS. 8A and 8B do not limit the scope of this disclosure to any particular implementation of a vehicle trading platform.

As shown in FIGS. 8A and 8B, the vehicle rule set interface 800 can include vehicle rule sets 204 that identify a particular type of vehicle in a dealership's vehicle acquisition plan. Each type of vehicle can be identified based on dealer-selected vehicle attributes 214, such as make, origin (like European or domestic), year(s), category (like car or truck), and model(s). Examples of vehicle attributes 214 supported for physical specifications in the vehicle rule set interface 800 can include a rule name 806, a priority 808, a rule description 810, an exclude special features option 812, a vehicle year range start date 814, a vehicle year range end date 816, a vehicle origin 818, a category 820, a select make 822, a select model 824, a bidding strategy 826, a maximum shipping cost 828, a vehicle rule switch 830, a vehicle rule start date 832, a rule last update log 834, and a vehicle rule created log 836.

The rule name 806 is a text giving a name to a vehicle rule 212 for recognition by the user. The rule name 806 can be unique within a buy matrix 130. This field may be searchable in the buy matrix user interface 304. The priority 808 is an integer that indicates the priority of the vehicle rule 212. The priority 808 defines the order in which the vehicle rules 212 are processed by buy matrix searches. The rule description 810 is an additional or alternative text for understanding the vehicle rule 212. This field is not required but is useful since it can be searchable from the buy matrix user interface 304 of all vehicle rule sets 204.

The exclude special features option 812 controls the activity of the special features at the vehicle rule level similar to the special feature setting 704 shown in FIG. 7 applied to the global rule level. When activated, vehicles purchased based on the vehicle rule 212 will not be eligible for the purchase of OFFERGUARD, even if the global rule setting for the special feature setting 704 is enabled.

The vehicle year range start date 814 is a start date for a range of years that the target vehicle was manufactured. The selection of the vehicle year range start date 814 can be inclusive for searching the year entered. The vehicle year range end date 816 is an end date for the range of years that the target vehicle was manufactured. The selection of the vehicle year range end date 816 can also be inclusive for searching the year entered. The vehicle origin 818 is a single pick option indicating an origin of the vehicle. Examples of the vehicle origin 818 could include “All regions,” “Import,” “Domestic,” “European,” etc. The category 820 is a single pick setting that can indicate a category of the target vehicle to search for. Examples of categories 820 can include “All,” “Car,” “Electric Vehicle,” “Exotics,” “Minivan,” “SUV/Crossover,” “Truck,” “Van,” etc. The select make 822 is a single pick setting indicating a make of the vehicle. Examples of select make 822 can include ACURA, HONDA, HYUNDAI, INFINITI, KIA, LEXUS, MAZDA, MITSUBISHI, NISSAN, SUBARU, TOYOTA, etc. The select model 824 is a multi-pick setting indicating model(s) of the vehicle based on the make of the vehicle. Examples of the select model(s) 824 for “TOYOTA” can include “AVALON,” “CAMRY,” etc.

The bidding strategy 826 is an automated display for a summary of the bidding strategy for the specific vehicle rule 212. The bidding strategy 826 could include an appraisal source, a quality of the target vehicle, and an adjusted bidding price for the target vehicle. The maximum shipping cost 828 is a currency value for the maximum amount of money a dealer is willing to spend in addition to the price of the target vehicle. The shipping cost is not included in the price of the matched offer 134 but is taken into consideration by the matrix match algorithm 112 when determining the matched offer 134. The vehicle rule switch 830 is a setting for controlling the activeness of the specific vehicle rule 212. The vehicle rule switch 830 can be turned off, in which case the matrix match algorithm 112 will not review the specific vehicle rule 212 for comparing to the target vehicle 128. The vehicle rule start date 832 is a setting for the start date of the vehicle rule 212. The vehicle rule switch 830 may automatically be enabled at the start date time. The rule last update log 834 indicates the user that most recently updated the vehicle rule 212 and the date when the vehicle rule 212 was most recently updated. The vehicle rule created log 836 indicates the user that initially created the vehicle rule 212 and the date that the vehicle rule 212 was created.

Once the dealer has configured the basic vehicle attributes 214 to physically specify the target vehicles 128 to acquire, the dealer submits a request to the server to get all vehicle models made in the specified year(s) that match the criteria. A grid of selections is displayed with each applicable year or model and the trim packages or options available for each model in that year.

In the vehicle rule set 204, the dealer can configure bid eligibility rules such as those based on mileage parameters, status such as whether “fresh trade” vehicles are eligible, and vehicle history such as whether vehicles with rental or accident history are eligible. In the vehicle rule set 204, the dealer can also configure specific options such as navigation and exterior color; specific options take precedence over options that may be configured as a package option in a vehicle spec combination 206. For example, if the specific option of navigation is set to “No,” then any vehicle spec combination 206 that includes navigation as a package option is ineligible.

Example of attributes supported for eligibility viewed in the expanded vehicle header 802 can include miles per year 838, minimum total mileage 840, maximum total mileage 842, fresh trade bid 844, accidents 846, rentals 848, navigation 850, sunroof 852, leather 854, transmission 856, drive train 858, engine cylinders 860, fuel type 862, and colors to exclude 864. The miles per year 838 is an integer value indicating the average miles per year over the life of the target vehicle 128. The miles per year 838 can be a maximum amount or a minimum amount for the average miles of target vehicles for generating an automatic offer. The minimum total mileage 840 is an integer value indicating a minimum amount of miles for purchasing a target vehicle. A target vehicle with less than the minimum amount of miles is not considered for making an automatic offer. The maximum total mileage 842 is an integer value indicating a maximum amount of miles for purchasing a target vehicle. A target vehicle with more than the maximum amount of miles is not considered for making an automatic offer. The fresh trade bid 844 is a toggle option for generating automatic bids on “fresh trades.” An example of a fresh trade would be one where a consumer has asked a dealer for an offer on the consumer's vehicle. The dealer can submit the vehicle as a target vehicle 128 to the matrix match algorithm 112 to get offer(s) which can help the dealer determine an amount to offer to the consumer as a trade-in allowance or outright purchase.

The accidents 846 is an eligibility setting to indicate whether the user would like to generate automatic bids on target vehicles 128 based on their accident history. The option allows for bidding on vehicles with no accidents, vehicles with accidents (only), or both. The rentals 848 is an eligibility setting indicating whether the user would like to generate automatic bids on target vehicles 128 based on their history of usage as rental vehicles. The option allows for bidding on target vehicles 128 that were rental vehicles, target vehicles 128 that were not rental vehicles, or both. The navigation 850, sunroof 852, and leather 854 are individual settings for whether automatic bids will be generated based on these specific features. The options to be selected would include “yes,” “no,” and “any.” The transmission 856 is a pick list that indicates a type of transmission of a target vehicle 128 for generating automatic offers. Examples of transmissions 856 can include “Any,” “Automatic,” and “Manual.” The drive train 858 is a pick list that indicates a type of drive train of a target vehicle 128 for generating automatic offers. Examples of drive train 858 can include “Any,” “4WD/AWD,” “FWD,” and “RWD.” The engine cylinders 860 is a pick list that indicates an amount of cylinders of a target vehicle 128 for generating automatic offers. Examples of engine cylinders 860 can include “Any,” “3,” “4,” “6,” etc. The fuel type 862 is a pick list that indicates a type of fuel consumed by a target vehicle 128 for generating automatic offers. Examples of fuel type 862 can include “Any,” “Gas,” “Diesel,” “Hybrid,” “Electric,” “CNG,” etc. The colors-to-exclude 864 is a pick list that indicates colors for a target vehicle 128 to exclude from generating automatic offers. Examples of colors-to-exclude 864 can include black, blue, brown, gold, gray, green, maroon, orange, pink, purple, red, silver, tan, white, yellow.

Each vehicle rule set 204 provides a bid strategy to apply to every potential acquisition in order to validate rules specific to the prospective vehicle and to arrive at an auto-calculated offer price. The vehicle rule set 204 can include monthly units to acquire 866, maximum transport cost 868, maximum shipping check box 870, maximum shipping distance 872, rule start date 874, rule end date 876, selected book 878, standard adjust value 880, offer adjustment 882, and maximum amount per unit 884.

The monthly units to acquire 866 is an integer value indicating an amount of target vehicles 128 to acquire under the vehicle rule 212. This value takes precedence over the value specified in the individual vehicle spec combinations 206. The monthly units to acquire 866 is subordinate to the values specified in the global rule set 202 for maximums per week and month. The maximum transport cost 868 is a currency amount indicating the maximum amount of transportation cost a buyer is willing to pay for shipping a target vehicle 128. A target vehicle that will cost more than the maximum transport cost 868 will not generate an automatic offer, unless (as described above) an excess amount of transport cost can be offset in a lower offer price. The maximum shipping distance check box 870 is a checkbox input for indicating that the maximum shipping distance should be considered when generating automatic offers. If the maximum shipping distance check box 870 is not checked, the matrix match algorithm 112 will not consider the shipping distance of the target vehicle 128 when generating automatic offers. The maximum shipping distance 872 is an integer value that indicates a maximum distance in miles for transport of the target vehicle 128. If the distance of the target vehicle 128 is greater than the maximum shipping distance, the matrix match algorithm 112 will not generate an automatic offer for the target vehicle 128.

The rule start date 874 is a date selector for the rule to be enabled. The default for the rule start date 874 may be the current date. The matrix match algorithm 112 will not considered vehicle rules 212 that have not reached the start date. The rule end date 876 can have a checkbox for no end date in addition to a date selector. The rule end date 876 can indicate a date when the vehicle rule 212 will be automatically disabled. The matrix match algorithm 112 will not consider the vehicle rule 212 after the selected date.

The selected book 878 is a single-pick selectable list of appraisal books for determining a value of the target vehicle 128. The matrix match algorithm 112 will use the specified appraisal book when generating automatic offers for the target vehicle. The standard adjusted value 880 is a single-pick list with quality items supported by the selected book 878. The pick list for standard adjusted value 880 is automatically populated with the selectable options when the selected book 878 is determined. The offer adjustment 882 provides multiple options for defining the dealer's offer adjustments in a bidding strategy. For example, the offer adjustment 882 can be determined by “percent or currency amount,” an amount expressed based on the “percent or currency amount,” and whether the adjustment is above the appraisal price or below the appraisal price. The maximum amount per unit 884 is a currency amount indicating a maximum currency value to offer on a single target vehicle. If the auto-calculated offer price for the target vehicle 128 is above the maximum amount per unit price, the matrix match algorithm does not generate a matched offer 134 for the target vehicle 128.

Here, the first portion (bid rules) determines whether a prospective vehicle needs to be eliminated from consideration based on factors such as the transport cost or transport (shipping) distance. The second portion provides the mechanism to calculate an offer price for any prospective vehicle based on the dealer's preferred book to use in determining book value and which standard adjusted value to apply to arrive at an initial value, as well as a dealer adjustment to apply to the initial value in order to arrive at the offer price for the vehicle. Once calculated, the offer price can be confirmed as not exceeding the maximum dollar amount per unit (vehicle) in the vehicle rule set 204.

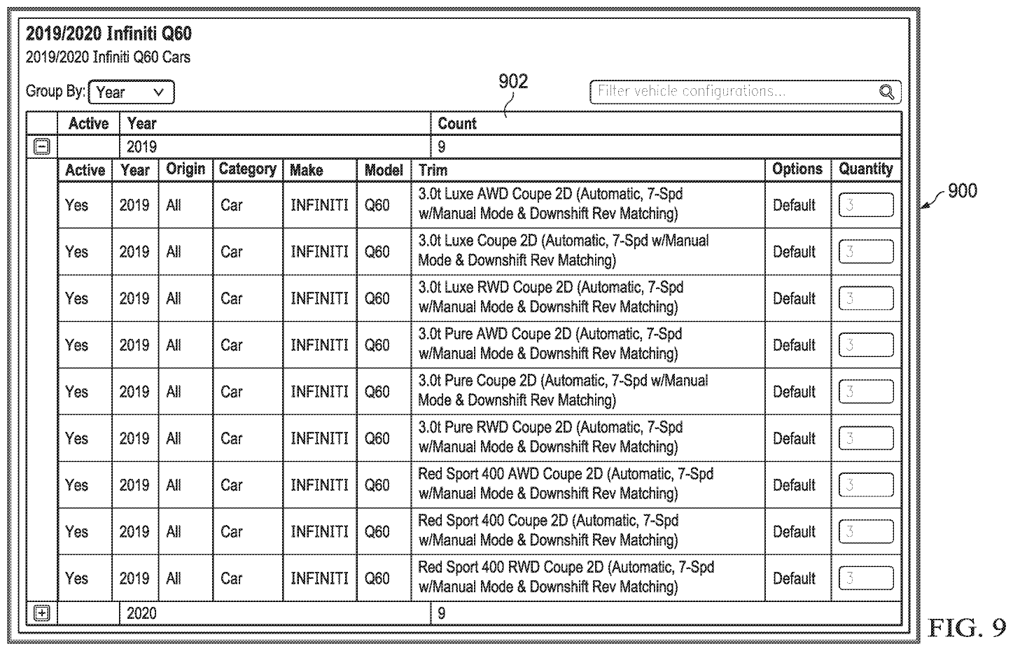

In FIG. 8B, the vehicle spec combinations 206 for the vehicle rule set 204 are grouped and collapsed by year, so they are not visible. The vehicle spec combinations 206 are shown in greater detail in FIG. 9.

Although FIGS. 8A and 8B illustrate one example of a vehicle rule set interface 800, various changes may be made to FIGS. 8A and 8B. For example, the vehicle rule set interface 800 may support any number of vehicle rules and be used in conjunction with any suitable number(s) and type(s) of external applications or systems.

FIG. 9 illustrates an example combination vehicle rule set and vehicle specification interface 900 according to embodiments of this disclosure. The combination vehicle rule set and vehicle specification interface 900 can be implemented in the buy matrix user interface 304 shown in FIG. 3 in order to define at least one vehicle spec combination 206. The embodiment of the vehicle rule set and vehicle specification interface 900 illustrated in FIG. 9 is for illustration only. FIG. 9 does not limit the scope of this disclosure to any particular implementation of a vehicle trading platform.

As shown in FIG. 9, after the user interface has enabled the dealer to select the model(s) and trim package(s) that the dealer wants to acquire, the grid of matching vehicle spec combinations 206 that match the dealer's selections based on data pulled from valuation books is displayed. The vehicle spec combinations 206 that are returned are displayed as data records, as shown in FIG. 9, and are used by the matrix match algorithm 112 to perform searches.

After the vehicle spec combinations 206 are generated, the dealer can customize each one's package options as needed, and pick list choices may be presented to ensure validity of selections. The dealer can also update the quantity cap 902 in each vehicle spec combination 206 as needed. The quantity cap 902 is used to help the dealer in acquiring a good mix of vehicles. This quantity cap 902 is subject to the overall quantity cap at the vehicle rule set 204 level. In addition to storing the vehicle spec combinations 206 as data records, the data may be stored in a document format to support enhanced searching for the system's accompanying algorithm.

Although FIG. 9 illustrates one example of a vehicle rule set and vehicle specification interface 900, various changes may be made to FIG. 9. For example, the vehicle rule set and vehicle specification interface 900 may support any number of vehicle spec combinations and be used in conjunction with any suitable number(s) and type(s) of external applications or systems.

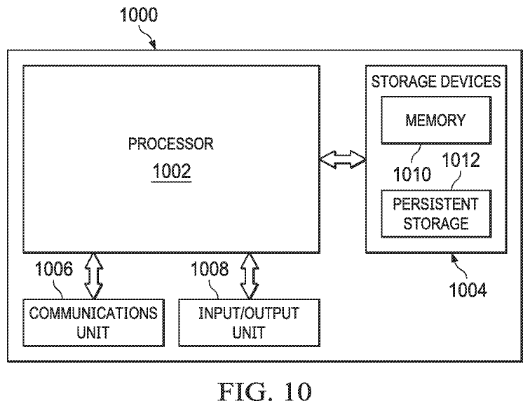

FIG. 10 illustrates an example device 1000 implemented with a vehicle trading platform 102 according to this disclosure. For example, one or more instances of the device 1000 may be used to implement the vehicle trading platform 102. One or more instances of the device 1000 may also be used to implement each external dealership management system 104, administration system 106, or listing provider system 108.

As shown in FIG. 10, the device 1000 includes at least one processor 1002, at least one storage device 1004, at least one communications unit 1006, and at least one input/output (I/O) unit 1008. Each processor 1002 can execute instructions, such as those that may be loaded into a memory 1010. Each processor 1002 denotes any suitable processing device, such as one or more microprocessors, microcontrollers, digital signal processors, application specific integrated circuits (“ASICs”), field programmable gate arrays (“FPGAs”), or discrete circuitry. The processor 1002 could execute any suitable instructions, such as those implementing at least part of a vehicle trading platform 102 with a buy matrix 130.

The memory 1010 and a persistent storage 1012 are examples of storage devices 1004, which represent any structure(s) capable of storing and facilitating retrieval of information (such as data, program code, and/or other suitable information on a temporary or permanent basis). The memory 1010 may represent a random access memory or any other suitable volatile or non-volatile storage device(s). The persistent storage 1012 may contain one or more components or devices supporting longer-term storage of data, such as a read only memory, hard drive, Flash memory, or optical disc. At least one of the storage devices 1004 here may be used to store information associated with at least one buy matrix.

Each communications unit 1006 supports communications with other systems or devices. For example, at least one communications unit 1006 could include one or more wired network transceivers or wireless radios. Each communications unit 1006 may support communications through any suitable physical or wireless communication link(s).

Each I/O unit 1008 allows for input and output of data. For example, the I/O unit 1008 may provide a connection for user input through a keyboard, mouse, keypad, touchscreen, or other suitable input device. The I/O unit 1008 may also send output to a display, printer, or other suitable output device. Note, however, that the use of the I/O unit 1008 for local I/O may not be needed, such as when the device 1000 is accessible locally or remotely over a network connection.

Although FIG. 10 illustrates one example of a device 1000 implemented with a vehicle trading platform 102, various changes may be made to FIG. 10. For example, various components in FIG. 10 could be combined, further subdivided, or omitted and additional components could be added according to particular needs. Also, computing and communication devices can come in a wide variety of configurations, and FIG. 10 does not limit this disclosure to any particular configuration of computing or communication device.

In some embodiments, various functions described in this patent document are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (“ROM”), random access memory (“RAM”), a hard disk drive, a compact disc (“CD”), a digital video disc (“DVD”), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable storage device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in this application should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A vehicle trading platform for providing seamless integration between different aspects of fleet management, the vehicle trading platform comprising:
at least one memory configured to store a buy matrix database including multiple buy matrices, wherein each buy matrix includes one or more purchasing rules; and
at least one processor configured to:
receive a specification of a target vehicle from a selling dealer;
compare the specification of the target vehicle with the purchasing rules of the buy matrices; and
provide a matched offer for the target vehicle to the selling dealer based on a result of comparing the specification of the target vehicle with the buy matrices

2. The vehicle trading platform of claim 1, wherein the one or more purchasing rules of each of the buy matrices includes at least one global rule and at least one vehicle rule for a buying dealer.

3. The vehicle trading platform of claim 2, wherein each global rule provides one or more purchasing limits for cumulative purchases across the at least one vehicle rule.

4. The vehicle trading platform of claim 3, wherein the one or more purchasing limits are based on at least one of: a total amount of money spent or a total quantity of vehicles purchased.

5. The vehicle trading platform of claim 3, wherein the at least one processor is further configured to:
compare the specification of the target vehicle with the at least one vehicle rule in each of the buy matrices;
for any buy matrix having a vehicle rule matching the specification of the target vehicle, determine whether the one or more purchasing limits of the at least one global rule corresponding the buy matrix have been fully satisfied; and
for any buy matrix having the vehicle rule matching the specification of the target vehicle and one or more unsatisfied purchasing limits, provide the matched offer for the target vehicle.

6. The vehicle trading platform of claim 5, wherein:
more than one buy matrix includes both (i) a vehicle rule matching the specification of the target vehicle and (ii) an unsatisfied purchasing limit; and
the at least one processor is configured to:
determine a shipping distance from a location of the target vehicle to a location for each of the more than one buy matrix;
calculate a shipping cost based on the shipping distance for each of the more than one buy matrix;
adjust a matched offer based on the shipping cost for each of the more than one buy matrix; and
provide the matched offers to the selling dealer.

7. The vehicle trading platform of claim 6, wherein the at least one processor is further configured to compare the shipping costs to a maximum shipping cost stored in each of the more than one buy matrix.

8. A method for providing a vehicle trading platform that supports seamless integration between different aspects of fleet management, the method comprising:
storing a buy matrix database including multiple buy matrices, wherein each buy matrix includes one or more purchasing rules;
receiving a specification of a target vehicle from a selling dealer;
comparing the specification of the target vehicle with the purchasing rules of the buy matrices; and
providing a matched offer for the target vehicle to the selling dealer based on a result of comparing the specification of the target vehicle with the buy matrices.

9. The method of claim 8, wherein the one or more purchasing rules of each of the buy matrices includes at least one global rule and at least one vehicle rule for a buying dealer.

10. The method of claim 9, wherein each global rule provides one or more purchasing limits for cumulative purchases across the at least one vehicle rule.

11. The method of claim 10, wherein the one or more purchasing limits are based on at least one of: a total amount of money spent or a total quantity of vehicles purchased.

12. The method of claim 10, further comprising:
comparing the specification of the target vehicle with the at least one vehicle rule in each of the buy matrices;
for any buy matrix having a vehicle rule matching the specification of the target vehicle, determining whether the one or more purchasing limits of the at least one global rule corresponding the buy matrix have been fully satisfied; and
for any buy matrix having the vehicle rule matching the specification of the target vehicle and one or more unsatisfied purchasing limits, providing the matched offer for the target vehicle.

13. The method of claim 12, wherein:
more than one buy matrix includes both (i) a vehicle rule matching the specification of the target vehicle and (ii) an unsatisfied purchasing limit; and
the method further comprises:
determining a shipping distance from a location of the target vehicle to a location for each of the more than one buy matrix;
calculating a shipping cost based on the shipping distance for each of the more than one buy matrix;
adjusting a matched offer based on the shipping cost for each of the more than one buy matrix; and
providing the matched offers to the selling dealer.

14. The method of claim 13, further comprising:
comparing the shipping costs to a maximum shipping cost stored in each of the more than one buy matrix.

15. A non-transitory computer readable medium containing instructions that when executed cause at least one processing device to:
store a buy matrix database including multiple buy matrices, wherein each buy matrix includes one or more purchasing rules;
receive a specification of a target vehicle from a selling dealer;
compare the specification of the target vehicle with the purchasing rules of the buy matrices; and
provide a matched offer for the target vehicle to the selling dealer based on a result of comparing the specification of the target vehicle with the buy matrices.

16. The non-transitory computer readable medium of claim 15, wherein the one or more purchasing rules of each of the buy matrices includes at least one global rule and at least one vehicle rule for a buying dealer.

17. The non-transitory computer readable medium of claim 16, wherein each global rule provides one or more purchasing limits for cumulative purchases across the at least one vehicle rule.

18. The non-transitory computer readable medium of claim 17, wherein the instructions when executed further cause the at least one processing device to:
compare the specification of the target vehicle with the at least one vehicle rule in each of the buy matrices;
for any buy matrix having a vehicle rule matching the specification of the target vehicle, determine whether the one or more purchasing limits of the at least one global rule corresponding the buy matrix have been fully satisfied; and
for any buy matrix having the vehicle rule matching the specification of the target vehicle and one or more unsatisfied purchasing limits, provide the matched offer for the target vehicle.

19. The non-transitory computer readable medium of claim 18, wherein:
more than one buy matrix includes both (i) a vehicle rule matching the specification of the target vehicle and (ii) an unsatisfied purchasing limit; and
the instructions when executed further cause the at least one processing device to:
determine a shipping distance from a location of the target vehicle to a location for each of the more than one buy matrix;
calculate a shipping cost based on the shipping distance for each of the more than one buy matrix;
adjust a matched offer based on the shipping cost for each of the more than one buy matrix; and
provide the matched offers to the selling dealer.

20. The non-transitory computer readable medium of claim 19, wherein the instructions when executed further cause the at least one processing device to compare the shipping costs to a maximum shipping cost stored in each of the more than one buy matrix.
